(19) United States
(12) Patent Application Publication
(10) Pub. No.: US 2011/0163597 A1
(43) Pub. Date: Jul. 7, 2011

(54) VEHICLE ELECTRICAL POWER MANAGEMENT APPARATUS AND VEHICLE ELECTRICAL POWER MANAGEMENT MODULE

(76) Inventors: Shih-Yao LIN, Sindian City (TW); Fang-Ming Hsieh, Jhonghe City (TW)

(21) Appl. No.: 12/729,557

(22) Filed: Mar. 23, 2010

(30) Foreign Application Priority Data
Jan. 6, 2010 (TW) 99200171

(51) Int. Cl. B60L 1/00

(52) U.S. Cl. 307/9.1

(57) ABSTRACT

A vehicle electrical power management module is capable of controlling electrical power supplying to an air conditioning load with respect to an overall amount of electrical power associated with a vehicle and an actual temperature value inside the vehicle. The vehicle electrical power management module comprises, an AC to DC conversion unit, a setup unit, a switching unit, and a micro-control unit. The AC to DC conversion unit transfers an AC input power to a DC input power. The setup unit outputs a standard temperature value with respect to a user setting. The switch unit is coupled to the DC to AC conversion unit. The micro-control unit receives the plurality of temperature signals from a number of temperature sensor units and controls the switch unit to supply power to a plurality of air conditioning loads in response to the plurality of temperature signals and the standard temperature value.

### BACKGROUND OF THE INVENTION

1. Field of the Invention

The present invention relates to an electrical power management module, in particular, to a vehicle electrical power management module which is capable of controlling electrical power supplying to an air conditioning load with respect to an overall amount of electrical power associated with a vehicle and an actual temperature value inside the vehicle.

2. Description of Related Art

With the growing popularity of sport utility vehicles, vehicles not only equip with essential electrical appliances, such as lights, a motor activator, meters, traffic controlling devices, air conditioning and ignition devices, but also equip with additional entertainment electrical appliances, such as audio and video players, refrigerators, or anti-theft devices. Because all kinds of electrical appliances will consume a number of electricity, and electricity consumed by a variety of electrical appliances influence each other, it getting important to manage electrical power effectively.

Among all of electrical appliances mentioned above, it is most important to control the air conditioning devices of a vehicle, because the management of the air conditioning devices is directly related to a comfort degree for a driver and passengers inside the vehicle. As vehicles are used to drive and travel in different external environments in a high speed, environmental temperatures inside the vehicles varies constantly corresponding to variation of external environmental conditions. Drivers are required to manually adjust the air conditioning devices so as to maintain the most comfortable driving environment inside the vehicles. Yet, drivers may distract from driving and affect driving safety by adjusting the air conditioning devices.

If internal spaces of vehicles are larger, a plurality of air conditioning devices is applied generally. The conventional technique is to switch the operations of the plurality of air conditioning devices regularly in turn. However, a disadvantage of the technique is unable to maintain regular environmental temperatures inside vehicles.

### SUMMARY OF THE INVENTION

As per the aforementioned technical issues, a primary objective of the present invention is to provide a vehicle electrical power management module which is capable of equalizing environmental temperatures inside a vehicle and preventing shutdown in an over-loaded condition in response to a limited electrical power supply of the vehicle. The vehicle electrical power management module may transmit and receive information from other electronic apparatuses by means of a communication interface, such that users may completely recognize the operating status of each electronic apparatus so as to allow remote control the operation of each electronic apparatus.

Therefore, a primary objective of the present invention is to provide a vehicle electrical power management module by setting a prioritize order for distributing electrical power to each load, such that more important loads with higher electrical power distribution priority may not be affected in power shortage. The vehicle electrical power management module may control operations of different air conditioning loads in response to the detected temperature values of different temperature detecting units, so as to prevent unequal temperature distribution inside a vehicle and turn off air conditioning loads once a temperature value set by a user is achieved, thereby achieving power-saving effects.

To achieve the aforementioned objectives, a vehicle electrical power management module according to the present invention is provided for controlling electrical power supplying to a plurality of air conditioning loads. The vehicle electrical power management module comprises an AC to DC conversion unit, a setup unit, a switching unit, and a micro-control unit. Herein, the AC to DC conversion unit coupled to an electrical power supply unit, for converting an AC input power to a DC input power; the setup unit, coupled to the AC to DC conversion unit, for outputting a standard temperature value in response to a user setting; the switching unit, coupled to the AC to DC conversion unit; and the micro-control unit, respectively coupled to a plurality of temperature detecting units, the AC to DC conversion unit, and the switching unit, for receiving a plurality of temperature signals from the plurality of temperature detecting units and controlling the switching unit to switch electrical power supplied to the plurality of air conditioning loads in response to the temperature signals with respect to the standard temperature value.

As such, an objective by equalizing temperature distribution inside the vehicle can be achieved by controlling the switch unit to switch electrical power supplying to the air conditioning loads in response to the detected temperature signals of the temperature detecting units receiving by the micro-control unit. Thus, an unequal temperature distribution issue of the conventional vehicle electrical power management module can be improved.

In order to further understand the techniques, means and effects the present invention takes for achieving the prescribed objectives, the following detailed description and included drawings are hereby referred, such that, through which, the purposes, features and aspects of the present invention can be thoroughly and concretely appreciated; however, the included drawings are provided solely for reference and illustration, without any intention to be used for limiting the present invention, whose full scope and dimension is described only in the later following claims.

### BRIEF DESCRIPTION OF THE DRAWINGS

FIG. 1 illustrates a block diagram of an embodiment of the vehicle electrical power management apparatus in accordance with certain aspects of the present technique;

FIG. 2 illustrates a circuit diagram of an embodiment of the vehicle electrical power management apparatus according to the present invention; and

FIG. 3 illustrates a schematic diagram of an embodiment in accordance with a remote monitoring module of the vehicle electrical power management module according to the present invention.

### DETAILED DESCRIPTION OF THE PREFERRED EMBODIMENTS

A vehicle electrical power management module of the present invention may adjust electrical power supplied to air conditioning load in response to environmental temperature inside a vehicle and may manage an overall amount of electrical power associated with the vehicle by setting a maximum input power, thereby achieving a comfort driving environment and attaining the intended power-saving effect.

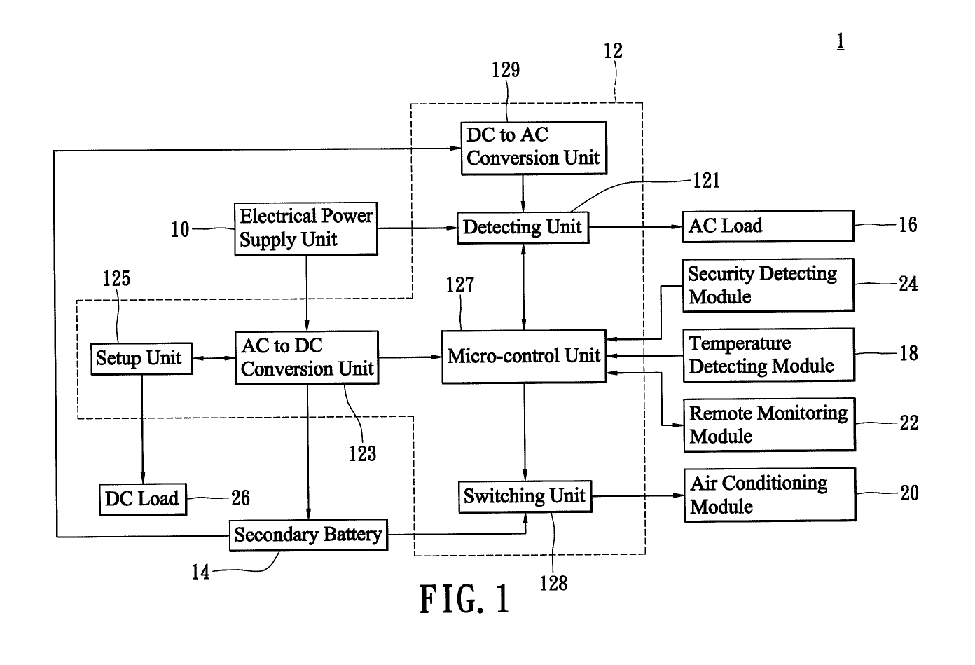

First please refer to FIG. 1, in which a block diagram of an embodiment of the vehicle electrical power management apparatus in accordance with certain aspects of the present technique is demonstrated. A vehicle electrical power management apparatus 1 comprises an electrical power supply unit 10, a vehicle electrical power management module 12, a secondary battery 14, an AC load 16, a temperature detecting module 18, an air conditioning module 20, a remote monitoring module 22, a security detecting module 24, and a DC load 26. Herein, the vehicle electrical power management module 12 couples to the electrical power supply unit 10, the secondary battery 14, the AC load 16, the temperature detecting module 18, the air conditioning module 20, the remote monitoring module 22, the security detecting module 24, and the DC load 26, respectively.

In the embodiment, the vehicle electrical power management module 12 detects a current or a power of an AC input power outputted from the electrical power supply unit 10 in response to a standard input power value associated with a user setting, wherein the standard input power value is the maximum input power. When the current or the power of AC input power exceeds that of the maximum input power, ex. 3600 VA or 30 A, the vehicle electrical power management module 12 may cut off or continue to supply electrical power to the AC load 16 in response to a specific switching procedure, thereby preventing the overall power consumption or the current from overloaded, wherein the quantity of the AC load 16 is higher than 1. the specific switching procedure is a prioritize order for distributing electrical power to a plurality of AC loads 16 in response to the importance of the plurality of AC loads 16 with respect to a user setting. As the current or the power of AC input power exceeds that of the maximum input power, the vehicle electrical power management module 12 first stops to apply electrical power on the AC loads 16 with lower priority until the current or the power of AC input power is lower than that of the maximum input power for preventing shutdown in an over-loaded situation which further influence the operations of the AC loads 16 with higher priority.

In the embodiment, the temperature detecting module 18 transmits the detected environmental temperature in the vehicle to the vehicle electrical power management module 12 by the communication interface, such as, RD-232 or RF wireless. The temperature detecting module 18 may connect to the vehicle electrical power management module 12 directly. The vehicle electrical power management module 12 monitors the environmental temperature inside the vehicle detected by the temperature detecting module 18 with respect to a standard temperature value set by a user. As the environmental temperature inside the vehicle exceeds the standard temperature value, ex. about 1˜2 degrees, a DC output power is provided to the air conditioning module 20; as the environmental temperature inside the vehicle may not exceed the standard temperature value, the electrical power discontinue to supply to the air conditioning module 20 for saving power.

Wherein, the air conditioning module 20 has a plurality of air conditioning loads, and the air conditioning loads are independent to each other. The temperature detecting module 18 has a plurality of temperature detecting units corresponding to the plurality of air conditioning loads. For example, if the air conditioning module 20 in the vehicle has two air conditioning loads, the temperature detecting module 18 also installs two temperature detecting units surrounding the two air conditioning loads respectively. The vehicle electrical power management module 12 may activate electrical power supplying to the two air conditioning loads in response to the standard temperature value, and after comparing the temperature values detected by the two temperature detecting units, the vehicle electrical power management module 12 may switch electrical power supplying to the two air conditioning loads in response to a specific power supplying procedure in accordance with air conditioning loads, thereby achieving an uniform and comfort environmental temperature inside the vehicle.

According to the embodiment, the vehicle electrical power management module 12 follows by a specific charging procedure with respect to battery types setting by users to charge the secondary battery 14. Furthermore, the vehicle electrical power management module 12 plays a role of temperature protection and temperature compensation associated with the secondary battery 14 and functions by detecting the surrounding temperature of the secondary battery 14 so as to control a charging voltage applied on the secondary battery 14 and extend a service life of the secondary battery 14.

Please refer to FIG. 1 again, the vehicle electrical power management module 12 comprises a detecting unit 121, an AC to DC conversion unit 123, a setup unit 125, a micro-control unit 127, a switching unit 128, and a DC to AC conversion unit 129. Therein, the detecting unit 121 and the AC to DC conversion unit 215 respectively couple to the electrical power supply unit 10; the setup unit 125 couples to the AC to DC conversion unit 123; the switching unit 128 couples to the AC to DC conversion unit 123 by way of the secondary battery 14; the DC to AC conversion unit 129 respectively couples to the secondary battery 14 and the detecting unit 121; the micro-control unit 127 couples to the detecting unit 121, the AC to DC conversion unit 123, the switching unit 128, the temperature detecting unit 18, the remote monitoring module 11, and the security detecting module 14, respectively.

Moreover, the electrical power supply unit 10 functions as an AC power supply of a motor generator, a vehicle backup generator, or a solar power supply. The AC power supply supplied by the motor generator is taken as an example for illustration according to the embodiment.

The AC to DC conversion unit 123 functions as a charging circuit, which first receives the AC input power outputted from the electrical power supply unit 10, then converts the AC input power to a DC input power, and finally outputs the DC input power converted to the secondary battery 14 and the setup unit 125; the setup unit 125 outputs a standard temperature value and a standard input power value in response to a user setting and outputs the DC input power outputted from the AC to DC conversion unit 123 to the DC load 26; after the detecting unit 121 detects the current or power of the AC input power, the detecting unit 121 outputs a first detecting signal.

The micro-control unit 127 receives the standard temperature value and the standard input power value of the setup unit 125 by means of the AC to DC conversion unit 123 and controls a DC output power outputted from the switching unit 128 to the air conditioning module 20 in response to a temperature signal detected by the temperature detecting module 18 and the standard temperature value. For example, the air conditioning module 20 has a plurality of air conditioning loads which are disposed in different spots of the vehicle respectively. Accordingly, a plurality of temperature detecting units is disposed in the spots nearby the plurality of the air conditioning loads. As the temperature signal detected by any one of the temperature detecting module 18 exceeds the standard temperature value, ex. about 1 degree, the micro control may control the switching unit 128 to output a DC power of the secondary battery 14 to either one of the plurality of air conditioning loads with respect to the specific power supplying procedure in accordance with the air conditioning loads.

Furthermore, the micro-control unit 127 controls the detecting unit 121 to output a first AC output power to the AC load 16 in response to the first detecting signal and the standard input power value, wherein the first detecting signal is the current or power of the AC input power. As the current or power of the AC input power exceeds that of the maximum input power, the micro-control unit 127 controls the detecting unit 121 to continue or discontinue supplying electrical power to the AC load 16 with respect to a specific switching procedure.

The DC to AC conversion unit 129 converts a DC power outputted from the secondary battery 15 to an AC power and outputs the AC power to the detecting unit 121. The detecting unit 121 outputs a second detecting signals in response to the AC power, and the micro-control unit 127 controls the detecting unit 121 to output a second AC output power to the AC load 16 in response to the second detecting signal and the standard input power value, wherein the second detecting signal is the current or power of the AC power. While the current or power of the AC power exceeds that of the maximum input power setting by the user, the micro-control unit 127 controls the detecting unit 121 to continue or discontinue supplying electrical power to the AC load 16 with respect to the specific switching procedure.

the setup unit 125 includes a switch (not shown) and an illuminating element (not shown), wherein the switching functions as a DIP switch, for users setting the types of secondary battery 14, setting the standard input power value (30 A or 50 A), and selecting a charging procedure, ex. a fast charging mode or a fine charging mode. The illuminating element may be a LED light, indicating a power supplying status or a over-loaded status of the AC to DC conversion unit 123, a power supplying status or a low voltage status of the secondary battery 14, a discontinuing power supply status of the DC load 26 and a power supplying status of the air conditioning module 20. In addition, the setup unit 125 may process setting via communication interfaces such as RD232, RD485 or RF wireless communication methods.

The setup unit 125 outputs a battery type signal in response to the user setting, the micro-control unit 127 outputs a charging procedure signal to the AC to DC conversion unit 123 in response to the battery type signal so as to perform different charging procedures with respect to different types of secondary battery 14. For example, when the DIP switch is on, the secondary battery 14 applied is a gel cell, and the micro-control unit 127 controls the AC to DC conversion unit 123 to perform a first charging procedure to the secondary battery 14; when the DIP switch is off, the secondary battery 14 applied is a VRLA cell or a AGM cell, and the micro-control nit 126 controls the AC to DC conversion unit 123 to perform a second charging procedure to the secondary battery 14 till charging for the secondary battery 12 is done. Wherein, the illuminating element may not merely indicate battery types but also display charging statuses and circuitry abnormality, etc.

The first charging procedure is to detect the battery voltage level first. If the voltage level of the battery is higher than a predetermined voltage level (13.2 V) and is at a float voltage level (13.7V) within a specific time (48 hours), the battery temporarily ceases charging until the voltage level of the battery falls down to the predetermined voltage. Similarly, the second charging procedure is to detect the battery voltage level. If the voltage level of the battery is lower than the predetermined voltage level (13.2 V), a fast charging voltage (14.4 V) is provided within a specific time (4 hours).

In the embodiment, the vehicle electrical power management module 12 further includes an over-temperature protection unit (not shown) coupled to the micro-control unit 127. The over-temperature protection unit is adjacent to the secondary battery 14 and outputs a battery temperature signal corresponding to the surrounding temperature of the secondary battery 14. The micro-control unit 127 controls the AC to DC conversion unit 123 to output different levels of charging voltages as a temperature compensation mechanism in response to the battery temperature signal.

The remote monitoring module 22 includes a display unit (not shown) and a operating unit (not shown) which are communicate to the vehicle electrical power management module 12 via a communication interface, ex. RS-232, RS-485, RF wireless, or internet network. Herein, the display unit is used to monitor the operating states and functional signals of the AC to DC conversion unit 123 and the DC to SC conversion unit 129, ex. a power supplying state or an over-loaded warning. The remote monitoring module 22 is further capable of monitoring the charging state of the secondary battery 14, observing the power supplying states of the air conditioning module 20 and the DC load 26, monitoring the detecting state of the security detecting module 24, and observing the environmental temperature value detected by the temperature detecting module 18. The operating unit functions as a operating interface for providing users to setup the standard temperature value and the standard input power value, so as to output a control signal to the micro-control unit 127. the operating unit is provided for users to setup the secondary battery type, setup the standard input power value (30 A or 50 A), and select the charging procedure, ex. a fast charging mode, etc.

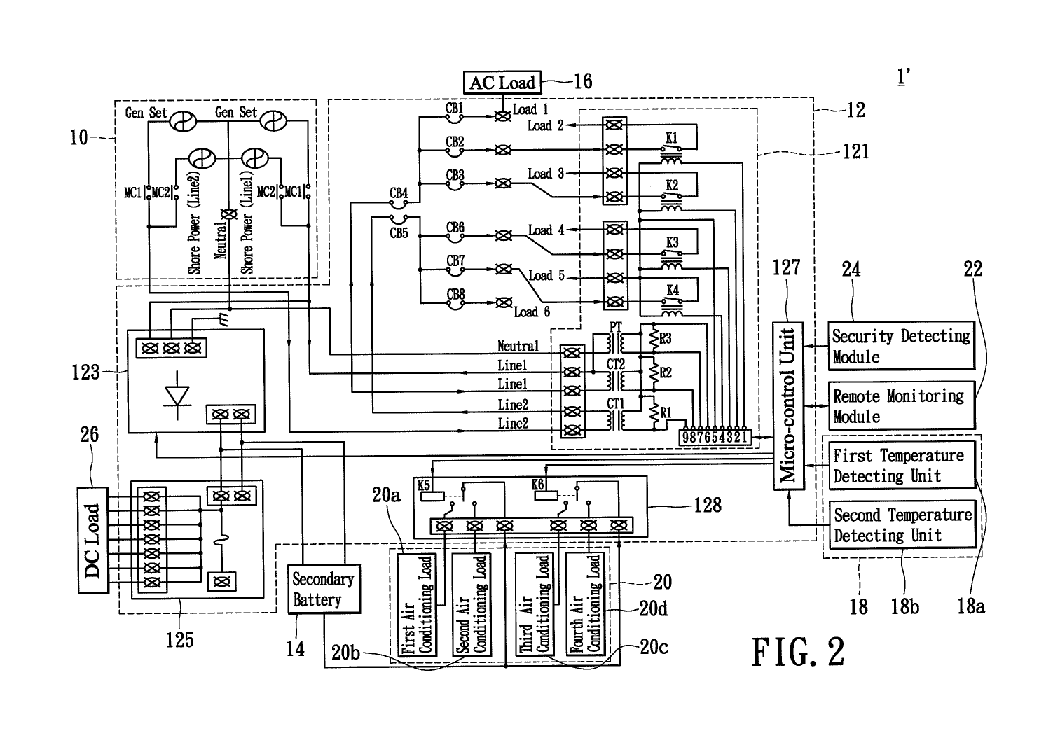

Next please refer to FIG. 2, in which a circuit diagram of an embodiment of the vehicle electrical power management apparatus according to the present invention is demonstrated. The vehicle electrical power management apparatus 1′ is almost identical to the vehicle electrical power management apparatus 1 as shown in FIG. 1, yet the only difference between them is the that the FIG. 2 further detailed exposes the internal elements of the vehicle electrical power management module 12 as shown in FIG. 2. To simplify the FIG. 2, the DC to AC conversion unit 129 is neglected.

In the embodiment, the vehicle electrical power management module 12 further comprises breakers CB1 to CB8, and the detecting unit 121 including at least one current transformer CT1, CT2, a power detector PT and relays K1 to K6. Herein, the current transformer CT1 couples to the electrical power supply unit 10 thru a line (Line2); the current transformer CT2 couples to the electrical power supply unit 10 thru a line (Line1); the breakers CB4 and CB5 couple to the current transformers CT2 and CT1 respectively; the breaker CB4 couples to AC loads Load1, Load2, and Load3 thru the breakers CB1, CB2, and CB3 respectively; the breaker CB5 couples to AC loads Load4, Load5, and Load6 thru the breakers CB6, CB7, and CB8 respectively; the relays K1, K2 respectively couple to the AC loads Load2, Load3; the relays K3, K4 respectively couple to the AC loads Load4, Load5; and the relays K5, K6 couple to the micro-control unit 127 respectively.

When a current of the input power detected by either one of the current transformers CT1, CT2 exceeds that of the standard input power value setting by the user, or the input power detected by the power detector PT exceed that of the standard input power value setting by the user, the micro-control unit 127 controls the relays K1 to K4 in order, such that the electrical power applying on the AC loads Load2 to Load5 are controlled in order as well. If the relay K1 discontinues to apply electrical power on the AC load Load2 and the current transformers CT1, CT2 detects the current higher than that of the standard input power value, the micro-control unit 127 controls the relay K2 to switch off so as to discontinue supplying electrical power to the AC load Load3, and so on and so forth until all relays are switched off. As the current smaller than that of the standard input power value, the relays K4 to K1 are switched in order, such that the electrical power supplying to the AC loads Load2 to Load5 is recovered and the breakers CB1 to CB3 and CB6 to CB8 function by protecting the circuitry in the end. In the embodiment, the prioritize order for discontinuing or recovering electrical power supplying to the AC loads Load2 to Load5 is arranged according to the importance of the AC loads in applications. Consequently, the most important AC loads Load1, Load6 are designed to be not controllable by the relay K1 to K4, yet the AC loads Load1, Load6 are designed to be protected by the breakers CB1, CB8.

In the embodiment, the secondary battery respectively couples to the relays K5, K6; the first air conditioning load 20a and the second air conditioning load 20b respectively couple to the secondary battery 14 by means of the relay K5; the third air conditioning load 20c and the fourth air conditioning load 20d respectively couple to the secondary battery 14 by means of the relay K6. For example, the relay K5 is switched with respect to the environmental temperatures, the relay K6 is switched regularly on time, the first temperature detecting unit 18a corresponds to the first air conditioning load 20a, and the second temperature detecting unit 18b corresponds to the second air conditioning load 20b.

The steps for controlling the first air conditioning load 20a and the second air conditioning load 20b in response to the environmental temperatures are as following: first, when the detected temperature of the first temperature detecting unit 18a or the second temperature detecting unit 18b exceeds the standard temperature value setting by the user, the micro-control unit 127 controls the relay K5 to switch to enable the secondary battery 14 supplying electrical power to the first air conditioning load 20a and the second air conditioning load 20b, then, comparing the temperature signal of the first temperature detecting unit 18a to the temperature signal of the second temperature detecting unit 18b; when the detected temperature signal of the first temperature detecting unit 18a exceeds the detected temperature signal of the second temperature detecting unit 18b, the micro-control unit 127 switches the relay K5 to supply electrical power to the first air conditioning load 20a and maintains for a specific period (ex. 10 minutes); nevertheless, when the detected temperature signal of the first temperature detecting unit 18a not exceeds the detected temperature signal of the second temperature detecting unit 18b, ex. lower than a specific temperature (ex. about 1 degree), the micro-control unit 127 switches the relay K5 to supply electrical power to the second air conditioning load 20b and maintains for a specific period (ex. 10 minutes). In conclusion, the relay K5 is switched to supply electrical power to the first air conditioning load 20a or to the second air conditioning load 20b with respect to the comparison result between the detected temperature signals of the first temperature detecting unit 18a and the second temperature detecting unit 18b. The relay K5 may not stop until either one of temperature detecting units 18a, 18b reaches the standard temperature value.

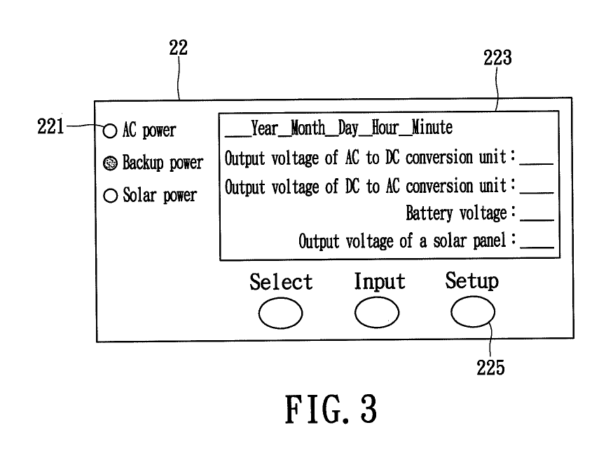

Finally please refer to FIG. 3, in which a schematic diagram of an embodiment in accordance with a remote monitoring module of the vehicle electrical power management module according to the present invention is demonstrated. The remote monitoring module 22 comprises a plurality of indicator lights 221, a display unit 223 and a operating unit 225, wherein the plurality of indicator lights 221 are used for indicating the present electrical power source of the vehicle electrical power management module 12; wherein the display unit 223 is used for displaying time, the output voltage of the AC to DC conversion unit 123, the output voltage of the DC to AC conversion unit 129, a output voltage of a solar panel, and the detecting signals of the security detecting module 24; herein, the operating unit 225 is provided for users to select the secondary battery type 14, select the charging procedure, and setup the standard input power value, etc.; while the setting of the remote monitoring module 22 is conflicted to the setting of the setup unit 22, the setting of the remote monitoring module 22 plays the main role.

In the aspects of the aforementioned embodiments, the vehicle electrical power management module according to the present invention may control the maximum input power so as to prevent discontinuing supplying electrical power in a over-loaded mode, communicate to peripheral electrical products thru communication interfaces, and further utilize the temperature detectors to detect the actual environmental temperature inside vehicles so as to monitor and adjust the air conditioning loads, thereby achieving a comfort and uniform environmental temperature inside the vehicles. As such, the vehicle electrical power management module according to the present invention may solve the unequal temperature distribution issue of the conventional vehicle air conditioning, switch to apply electrical power on AC loads with respect to the input current and input power, so that the present invention may manage electrical power effectively under a condition with limited electrical power, by distributing the limited electrical power in accordance with the prioritize order of the loads setting by users in order and incorporates with the security detecting module to perform surveillance.

The aforementioned descriptions represent merely the preferred embodiment of the present invention, without any intention to limit the scope of the present invention thereto. Various equivalent changes, alterations, or modifications based on the claims of present invention are all consequently viewed as being embraced by the scope of the present invention.

What is claimed is:

1. A vehicle electrical power management module, adapted for controlling electrical power supplied to a plurality of air conditioning loads, comprising:
an AC to DC conversion unit, coupled to an electrical power supply unit, for converting an AC input power to a DC input power;
a setup unit, coupled to the AC to DC conversion unit, for outputting a standard temperature value in response to a user setting;
a switching unit, coupled to the AC to DC conversion unit; and
a micro-control unit, respectively coupled to a plurality of temperature detecting units, the AC to DC conversion unit, and the switching unit, for receiving a plurality of temperature signals from the plurality of temperature detecting units and controlling the switching unit to switch electrical power supplied to the plurality of air conditioning loads in response to the temperature signals with respect to the standard temperature value, wherein the temperature detecting units corresponds to the air conditioning loads.

2. The vehicle electrical power management module according to claim 1, wherein the AC to DC conversion unit is a charging circuit which is able to output a charging voltage to a secondary battery, wherein the secondary battery outputs a DC electrical power.

3. The vehicle electrical power management module according to claim 2, wherein the micro-control unit compares the plurality of temperature detecting signals to the standard temperature value, so that whenever either one of the temperature detecting signals is higher than the standard temperature value, the micro-control unit controls the switching unit to be switched to the air conditioning load in corresponding to the temperature detecting unit which is detected to have the temperature detecting signal higher than the standard temperature value for supplying electrical power.

4. The vehicle electrical power management module according to claim 3, wherein the micro-control unit sorts the temperature values among the plurality of temperature detecting signals from high to low and controls the switching unit to prioritize electrical power supplying to the air conditioning loads in corresponding to the temperature detecting signals representing higher temperature values.

5. The vehicle electrical power management module according to claim 4, further including a detecting unit, coupled to the electrical power supply unit, for outputting a first detecting signal in response to the AC input power.

6. The vehicle electrical power management module according to claim 5, wherein the setup unit outputs a standard input power value with respect to a user setting.

7. The vehicle electrical power management module according to claim 6, wherein the micro-control unit controls the detecting unit to output a first AC output power in response to the first detecting signal and the standard input power value.

8. The vehicle electrical power management module according to claim 7, further including a DC to AC conversion unit, respectively coupled to the detecting unit and the secondary battery, for converting the AC electrical power outputted from the secondary battery to an AC electrical power and outputting the AC electrical power to the detecting unit

9. The vehicle electrical power management module according to claim 8, wherein the detecting unit outputs a second detecting signal in response to the AC electrical power.

10. The vehicle electrical power management module according to claim 9, wherein the micro-control unit controls the detecting unit to output a second AC output power in response to the second detecting signal and the standard input power value.

11. The vehicle electrical power management module according to claim 2, wherein the setup unit outputs a battery type signal in response to a user setting.

12. The vehicle electrical power management module according to claim 11, wherein the micro-control unit outputs a charging process signal to the AC to DC conversion unit in response to the battery type signal.

13. The vehicle electrical power management module according to claim 12, further including a over-temperature protecting unit, coupled to the micro-control unit, for outputting a battery temperature signal with respect to a surrounding temperature of the secondary battery.

14. The vehicle electrical power management module according to claim 13, wherein the micro-control unit controls the AC to DC conversion unit to output the charging voltage in response to the battery temperature signal.

15. The vehicle electrical power management module according to claim 1, wherein the detecting unit includes a current transformer.

16. The vehicle electrical power management module according to claim 1, wherein the micro-control unit couples to a remote monitoring module being outputting a control signal to the micro-control unit.

17. A vehicle electrical power management apparatus, adapted for controlling an environmental temperature inside a vehicle, comprising:
a plurality of air conditioning load;
a plurality of temperature detecting components, being respectively detecting surrounding temperatures of the plurality of air conditioning load;
a secondary battery, coupled to the AC to DC conversion unit, for outputting a standard temperature value in response to a user setting;
a switching unit, for storing an electrical power; and
a vehicle electrical power management module, coupled to an electrical power supply unit, the secondary battery, the air conditioning load, and a temperature detecting module, for converting an AC input power to a DC input power, then charging the secondary battery, and switching electrical power supplied to the plurality of air conditioning load in response to the surrounding temperatures of the air conditioning loads.

18. The vehicle electrical power management apparatus according to claim 17, wherein the vehicle electrical power management module includes:
an AC to DC conversion unit, coupled to the electrical power supply unit, for converting the AC input power to the DC input power;
a setup unit, coupled to the AC to DC conversion unit, for outputting a standard temperature value in response to a user setting;
a switching unit, coupled to the AC to DC conversion unit; and
a micro-control unit, respectively coupled to a plurality of temperature detecting units, the AC to DC conversion unit, and the switching unit, for receiving a plurality of temperature signals from the plurality of temperature detecting units and controlling the switching unit to switch electrical power supplied to the plurality of air conditioning loads in response to the temperature signals with respect to the standard temperature value.

19. The vehicle electrical power management apparatus according to claim 18, wherein the setup unit includes a switch and an illuminating element.

20. The vehicle electrical power management apparatus according to claim 17, further including a remote monitoring module, coupled to the vehicle electrical power management module.
